(19) United States
(12) Patent Application Publication
(10) Pub. No.: US 2020/0053413 A1
(43) Pub. Date: Feb. 13, 2020

(54) SIMPLIFIED UNIVERSAL REMOTE CONTROL

(71) Applicant: Chia-Hao Lin, Taipei City (TW)

(72) Inventor: Chia-Hao Lin, Taipei City (TW)

(21) Appl. No.: 16/532,497

(22) Filed: Aug. 6, 2019

(30) Foreign Application Priority Data
Aug. 10, 2018 (TW) 107210935

(51) Int. Cl. H04N 21/422

(52) U.S. Cl. CPC H04N 21/4221

(57) ABSTRACT

A simplified universal remote control includes a remote control body, a set-top box playing/pause button, a mute mode button, volume adjustment buttons, channel switching buttons, a control module, and a wireless transmission module. The remote control body includes a holding piece extended in a left-lower direction and a holding piece extended in a right-lower direction. The control module receives an operation signal from the operation interface and transmits a control signal. The wireless transmission module transmits the control signal to drive switching of playing and pause of a set-top box, switching of a mute mode, adjusting volume, or switching channels, so that a simplified, concise, and reasonable arrangement of buttons is provided to help greatly reduce the risk of erroneous button touch or push so as to realize the most optimum and most intuitive experience of use.

### TECHNICAL FIELD OF THE INVENTION

The present invention provides a simplified universal remote control, and more particularly to a television remote control that has a concise appearance design and a simplified and reasonable arrangement of buttons and is easy to operate.

### DESCRIPTION OF THE PRIOR ART

The progress and development of the television and audio/video technology bring high popularization rate of televisions in modern families. The television is also a major measure of communication and dissemination. Various and diversified devices, such as digital top-set boxes, movie-on-demand (MOD), and smart digital set-top boxes, have been developed and are available due to commercial competition. A set-top box allows a viewer to watch more than 20 wireless television channels. MOD provides specific channels that are available from local telecommunication carriers, plus various diversified functions carrying games and movies. A smart digital set-top box provides high definition television programs over hundreds of channels and is also available for multimedia broadcasting, and also include various built-in entertainment audio and video functions such as karaoke.

However, with the increasing expansion of additional functionality of a television, such as powering on/off a television, switching a set-top box, switching among signal sources, switching among various operation modes, displaying program messages, returning function, listing function, channel buttons, digit buttons, volume buttons, sound channel switching, language selection, muting function, and multimedia buttons, to ease the operation that a user might need to carry out, such additional functions are often provided in a one-button-one-function based control manner This leads to an arrangement of around 40 to 60 buttons provided on a single television remote control, causing certain disadvantages, such as increasing size expansion, complicated manufacturing, and high cost of remote controls, and also being inconvenient for users to operate.

Further, to enable one-hand operation and easy stowage, the television remote controls are often shaped with an elongate outer contour. To provide 40 to 60 buttons on such an elongate configuration, the size of each button and the distance between adjacent buttons must be both reduced. This makes it easy for a user to make erroneous pushing of the buttons and repeated operations or returning back to the previous state have to be additionally performed.

Generally, for the elderly whose vision perception is relatively weak or vision-impaired viewers who have vision problems, it is even more easier to make erroneous button pushing in operating or using a television remote control, and may get stuck in certain conditions without being capable of returning to the previous viewing condition or mode due to the complexity of button arrangement on the remote control, making them have to shut down and re-start the television, or seeking helps from other persons. This may lead to missing of programs and suffering of poor experience of watching due to the undesired interruption of viewing or negative emotional influence.

On the other hand, it is often for television viewers to watch television program while being having a meal or staying with other family members. Thus, the viewers might need to eat the meal and use hands to pick up a phone call or to handle other things. Under such a condition, switching channels, adjusting volume, or making muting would be a difficult job as the hands may have residues or juicy of food attached thereto, or the hands have to continue the previous operation of other things and are not available for operating the remote control. Most people use other parts of their bodies to push or contact the buttons of the remote control, such as elbow, wrist, or the back of a hand. The existing remote controls that are currently available in the markets are structured to have buttons of which the size is small and the spacing distance is short, making such operations of the remote control with other parts of human bodies extremely difficult and erroneous pushing occurs often.

Thus, it is desired in the fields of television multimedia business and product design industry to provide a new technology that overcomes the common shortcomings of the existing television remote controls that are available in the market and also enhances users' experiences.

### SUMMARY OF THE INVENTION

In other words, this invention is made to provide a simplified universal remote control. A novel technique provided in the disclosure overcomes the common shortcomings of the existing remote controls that are currently available in the market and also helps enhance users' experiences and reduces manufacturing costs.

In other words, the present invention provides a simplified universal remote control, which comprises: a remote control body, which is formed of an upper casing member and a lower casing member, the upper casing member and the lower casing member being of symmetrical structures, the upper casing member at least including an upper-casing leftward holding piece extended in a left-lower direction and an upper-casing rightward holding piece extended in a right-lower direction, the lower casing member at least including a lower-casing leftward holding piece extended in the left-lower direction and a lower-casing rightward holding piece extended in the right-lower direction; a set-top box playing/pause button, which is arranged at one side of a part that is located upward of a center of the upper casing member or the lower casing member; a mute mode button, which is arranged at an opposite side of the part that is located upward of a center of the upper casing member or the lower casing member; two volume adjustment buttons, which are respectively arranged at one side and an opposite side of a central part of the upper casing member or the lower casing member; two channel switching buttons, which are respectively arranged at an end or a central location of the upper-casing leftward holding piece and an end or a central location of the upper-casing rightward holding piece of the upper casing member or an end or a central location of the lower-casing leftward holding piece and an end or a central location of the lower-casing rightward holding piece of the lower casing member; a control module, which is arranged in an accommodation space formed by the upper casing member and the lower casing member combined to each other, the control module being electrically connected with the set-top box playing/pause button, the mute mode button, the two volume adjustment buttons, and the two channel switching buttons to receive an operation signal from the set-top box playing/pause button, the mute mode button, the two volume adjustment buttons, and the two channel switching buttons and transmitting, in response thereto, a control signal; and a wireless transmission module, which is electrically connected with the control module to transmit the control signal to drive switching of set-top box playing and pause, switching of mute mode, adjusting of volume, and switching of channel switching, wherein the set-top box playing/pause button, the mute mode button, the two volume adjustment buttons, and the two channel switching buttons each have an outer contour that has a shape of one of a circle, a square, a triangle, a rhombus, or a combination thereof.

Further, according to a specific embodiment of the simplified universal remote control of the present invention, the set-top box playing/pause button, the mute mode button, the two volume adjustment buttons, and the two channel switching buttons are all arranged on a surface of the upper casing member.

Further, according to another specific embodiment of the simplified universal remote control of the present invention, the set-top box playing/pause button, the mute mode button, the two volume adjustment buttons, and the two channel switching buttons are arranged on the surface of the upper casing member such that every two adjacent ones of the buttons are spaced from each other by a constant distance.

Further, according to a further specific embodiment of the simplified universal remote control of the present invention, at least one of the set-top box playing/pause button, the mute mode button, the two volume adjustment buttons, and the two channel switching buttons is arranged on a surface of the lower casing member.

Further, according to yet a further specific embodiment of the simplified universal remote control of the present invention, the set-top box playing/pause button, the mute mode button, the two volume adjustment buttons, and the two channel switching buttons have outside colors that are of a same color, a same color system, different colors, or different color systems.

Further, according to yet a further specific embodiment of the simplified universal remote control of the present invention, every two of the set-top box playing/pause button, the mute mode button, the two volume adjustment buttons, and the two channel switching buttons have sizes that are identical or different.

Further, according to yet a further specific embodiment of the simplified universal remote control of the present invention, a set-top box switch button that is arranged on the upper casing member or the lower casing member is further included.

Further, according to a specific embodiment of the simplified universal remote control of the present invention, the set-top box switch button has an outer contour that has a shape of one of a circle, a square, a triangle, a rhombus, or a combination thereof.

Further, according to a specific embodiment of the simplified universal remote control of the present invention, an indicator light arranged on the upper casing member or the lower casing member is further included, and the indicator light displays at least one color according to the control signal.

Further, according to a specific embodiment of the simplified universal remote control of the present invention, a setting button that is arranged on the upper casing member or the lower casing member is further included.

Further, according to a specific embodiment of the simplified universal remote control of the present invention, wherein the control signal is a signal that is transmittable through infrared light, Bluetooth, Bluetooth Low Energy (BLE), Zigbee, near field communication (NFC), wireless local area networking (Wi-Fi).

Further, the present invention also provides a simplified universal remote control, which comprises a casing, an operation interface, a control module, and a wireless transmission module, wherein the operation interface is arranged on a surface of the casing and includes a set-top box playing/pause button, a mute mode button, two volume adjustment buttons, and two channel switching buttons; the control module is arranged in an interior of the casing and is electrically connected with the operation interface to receive an operation signal from the operation interface and transmit a control signal; and the wireless transmission module is electrically connected with the control module and the wireless transmission module transmits the control signal to control operations of switching a television on/off, switching a mute mode, adjusting volume, or switching channels.

In an embodiment of the simplified universal remote control according to the present invention, the operation interface that is arranged on the surface of the casing is divided into a first group, a second group, and a third group, wherein buttons included in the first group are arranged on an upper part of the casing and include the set-top box playing/pause button and the mute mode button; buttons included in the second group are arranged on a central part of the casing and include the volume adjustment buttons; and buttons included in the third group are arranged on a lower part of the casing and include the channel switching buttons.

In an embodiment of the simplified universal remote control according to the present invention, the buttons of the first group further include a set-top box switch and the buttons are, in sequence, the mute mode button, the set-top box switch, and the set-top box playing/pause button.

In an embodiment of the simplified universal remote control according to the present invention, the buttons of the first group have a button color that is different from a button color of the buttons of the second group and a button color of the buttons of the third group; the button color of the buttons of the second group is different from the button color of the buttons of the third group.

In an embodiment of the simplified universal remote control according to the present invention, a spacing distance of each of the set-top box playing/pause button, the mute mode button, the set-top box switch button, the volume adjustment buttons, and the channel switching buttons and a different button that is closest thereto is identical.

In an embodiment of the simplified universal remote control according to the present invention, the set-top box playing/pause button, the mute mode button, and the set-top box switch button are each at least one of a circular button, a rectangular button, and a triangular button.

In an embodiment of the simplified universal remote control according to the present invention, the volume adjustment buttons are each at least one of a circular button, a rectangular button, and a triangular button.

In an embodiment of the simplified universal remote control according to the present invention, wherein the channel switching buttons are each at least one of a circular button, a rectangular button, and a triangular button.

In an embodiment of the simplified universal remote control according to the present invention, the casing is provided with an indicator light, and the indicator light displays at least one color to display each control signal of the same kind.

### BRIEF DESCRIPTION OF THE DRAWINGS

FIG. 1 is a schematic view showing an outside appearance of a representative example of a simplified universal remote control according to an embodiment of the present invention.

FIG. 2 is a schematic view showing an inside structural arrangement of a representative example of a simplified universal remote control according to an embodiment of the present invention.

FIG. 3 is a schematic view showing an outside appearance of a representative example of a simplified universal remote control according to an embodiment of the present invention.

### DETAILED DESCRIPTION OF THE PREFERRED EMBODIMENT

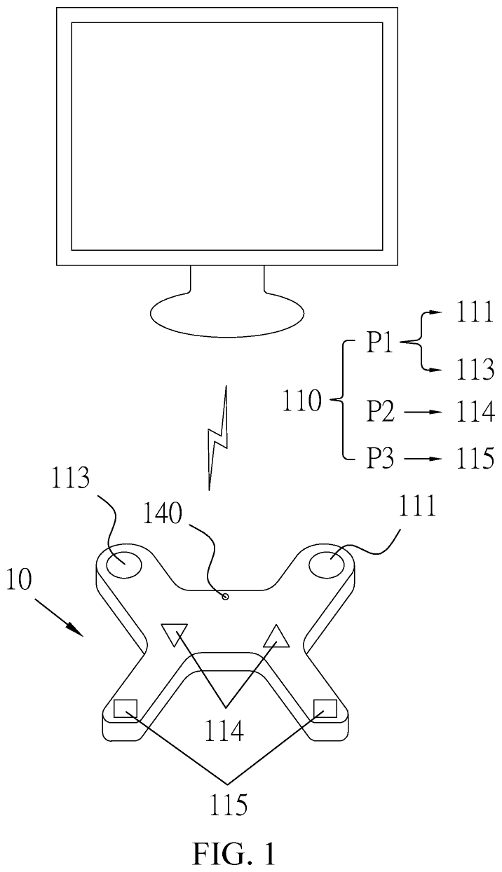

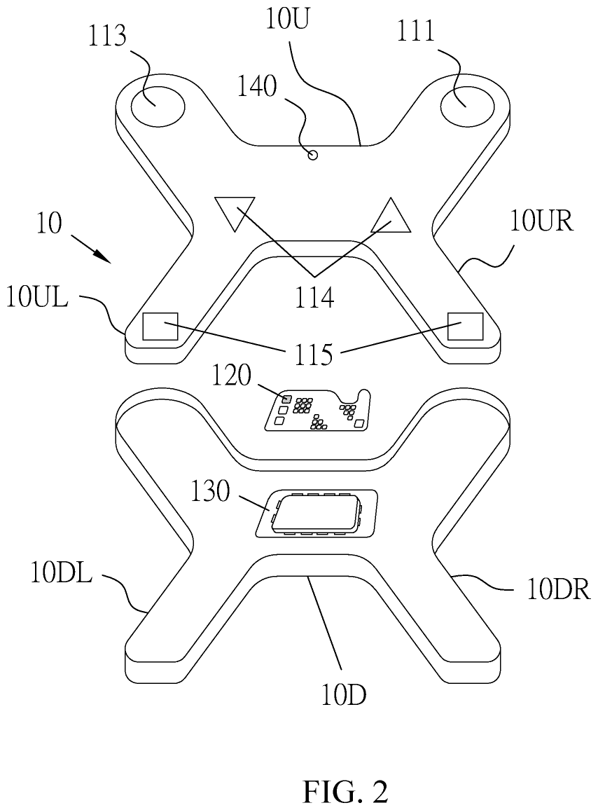

Firstly, reference is made to FIGS. 1, and 2. In a representative example of embodiment shown in FIGS. 1 and 2, a simplified universal remote control 10 according to the present invention comprises a casing 100, an operation interface 110, a control module 120, and a wireless transmission module 130, wherein the operation interface 110 is arranged on a surface of the casing 100 and includes a set-top box playing/pause button 111, a mute mode button 113, two volume adjustment buttons 114, and two channel switching buttons 115; the control module 120 is arranged in an interior of the casing 100 and is electrically connected with the operation interface 110 to receive an operation signal from the operation interface 110 and transmit a control signal; and the wireless transmission module 140 is electrically connected with the control module 120 and the wireless transmission module 140 transmits the control signal S2 to control operations of switching a television on/off, switching a mute mode, adjusting volume, or switching channels.

Further, the remote control body 10 is alternatively formed of an upper casing member 10U and a lower casing member 10D. The upper casing member 10U and the lower casing member 10D are arranged as symmetric structures. The upper casing member 10U at least includes an upper-casing leftward holding piece 10UL that is extended out in a left-lower direction and an upper-casing rightward holding piece 10UR that is extended out in a right-lower direction; and the lower casing member 10D at least includes a lower-casing leftward holding piece 10DL that is extended in the left-lower direction and a lower-casing rightward holding piece 10DR that is extended in the right-lower direction.

Further, the operation interface 120 that is arranged on the surface of the casing 100 is divided into a first group P1, a second group P2, and a third group P3, wherein buttons included in the first group P1 are arranged on an upper part of the casing 100 and include the set-top box playing/pause button 111 and the mute mode button 113; buttons included in the second group P2 are arranged on a central part of the casing and include the volume adjustment buttons 114; and buttons included in the third group P3 are arranged on a lower part of the casing 100 and include the channel switching buttons 115.

According to a technical idea of the present invention, the upper casing member 10U or the lower casing member 10D is provided with an indicator light 140, and the indicator light 140 displays at least one color to exhibit each control signal of the same kind. For example, for a function of operating a power switch, a red indication lighting signal is displayed; for operation of the set-top box switch, a yellow indication lighting signal is displayed, such that by means of the different indication lighting signals, it is possible to identify is the remote control is issuing a correct control signal.

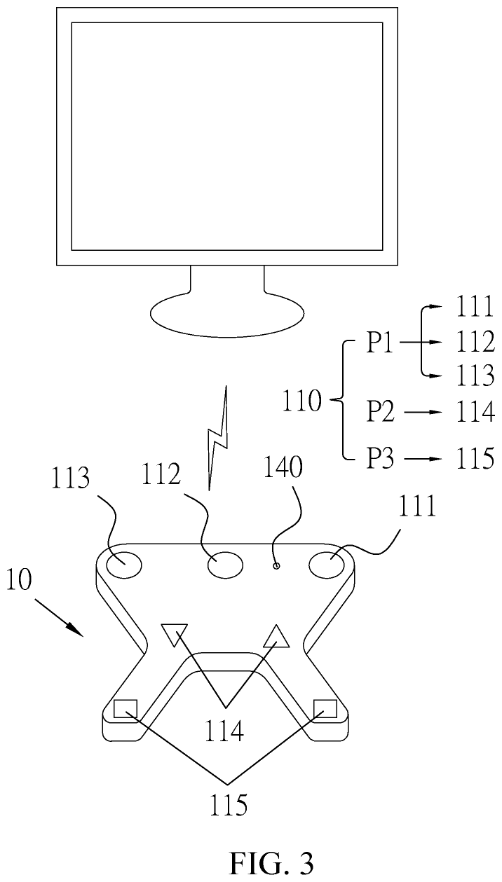

Reference is now made to FIG. 3. As shown in FIG. 3, the buttons of the first group P1 further include a set-top box switch 112 and the buttons are, in sequence, the mute mode button 113, the set-top box switch 112, and the set-top box playing/pause button 111.

According to a technical idea of the present invention, the buttons of the first group P1 have a button color that is different from a button color of the buttons of the second group P2 and a button color of the buttons of the third group P3; the button color of the buttons of the second group P2 is different from the button color of the buttons of the third group P3.

According to a technical idea of the present invention, a spacing distance of each of the set-top box playing/pause button 111, the set-top box switch button 112, the mute mode button 113, the volume adjustment buttons 114, and the channel switching buttons 115 and a different button that is closest thereto is identical and being provided as a sufficient inter-button distance, a user is allowed to contact and push the buttons with a part of the user's body that is other than fingers, such as the back of a hand, a wrist, and an elbow, or other parts of the body, and such a sufficient spacing distance makes a bottom surface area of the casing wider than an existing television remote control that is currently available in the market to thereby enhance stability of operation that helps prevent tilting or turning when a force is applied to the buttons.

Following the above description, when the closest button to each of the buttons is arranged with the same spacing distance, during the process of operation, hand touching or sight perception through eye corner would be sufficient to roughly identify the relative positions and distribution of the buttons so that operation of the remote control can be done without staring at the buttons. Further, button grouping is done with the frequency of operation of the buttons and practical uses thereof and this would greatly improve convenience of use and reduce the chances of erroneous touch or push of undesired buttons.

According to a technical idea of the present invention, the set-top box playing/pause button 111, the set-top box switch button 112 and the mute mode button 113 are each at least one of a circular button, a rectangular button, and a triangular button.

In an embodiment of the present invention, the volume adjustment buttons 114 are each at least one of a circular button, a rectangular button, and a triangular button.

In an embodiment of the present invention, the channel switching buttons 115 are each at least one of a circular button, a rectangular button, and a triangular button.

Following the above description, different ones of the buttons are provided with picturized features to achieve a function of recognition, making it possible to more easily distinguish and memorize the functions of the buttons, and this can be used in combination with assignment of different colors to make the operation interesting, more efficient, and more intuitive.

Further, according to a technical idea of the present invention, the control signal transmitted from the wireless transmission module is a signal that is transmittable through infrared light, Bluetooth, Bluetooth Low Energy (BLE), Zigbee, near field communication (NFC), wireless local area networking (Wi-Fi).

Further, according to a technical idea of the present invention, the simplified universal remote control may further comprises a setting button (not shown) that is arranged on one of the upper casing member 10U and the lower casing member 10D, and the function button can be arranged as a button for a learning function for learning a remote control function of a television, a set-top box, a DVD device, a projector, or other electrical appliances.

In conclusion of the description and illustration related to the embodiments provided above, it can be recognized that the simplified universal remote control disclosed in the present invention could overcome the common shortcomings of the prior art remote control techniques and also provide a simplified, concise, and reasonable arrangement of buttons that helps greatly reduce the risk of erroneous button touch or push so as to realize the most optimum and most intuitive experience of use.

I claim:

1. A simplified universal remote control, comprising:
a remote control body, which is formed of an upper casing member and a lower casing member, the upper casing member and the lower casing member being of symmetrical structures, the upper casing member at least including an upper-casing leftward holding piece extended in a left-lower direction and an upper-casing rightward holding piece extended in a right-lower direction, the lower casing member at least including a lower-casing leftward holding piece extended in the left-lower direction and a lower-casing rightward holding piece extended in the right-lower direction;
a set-top box playing/pause button, which is arranged at one side of a part that is located upward of a center of the upper casing member or the lower casing member;
a mute mode button, which is arranged at an opposite side of the part that is located upward of a center of the upper casing member or the lower casing member;
two volume adjustment buttons, which are respectively arranged at one side and an opposite side of a central part of the upper casing member or the lower casing member;
two channel switching buttons, which are respectively arranged at an end or a central location of the upper-casing leftward holding piece and an end or a central location of the upper-casing rightward holding piece of the upper casing member or an end or a central location of the lower-casing leftward holding piece and an end or a central location of the lower-casing rightward holding piece of the lower casing member;
a control module, which is arranged in an accommodation space formed by the upper casing member and the lower casing member combined to each other, the control module being electrically connected with the set-top box playing/pause button, the mute mode button, the two volume adjustment buttons, and the two channel switching buttons to receive an operation signal from the set-top box playing/pause button, the mute mode button, the two volume adjustment buttons, and the two channel switching buttons and transmitting, in response thereto, a control signal; and
a wireless transmission module, which is electrically connected with the control module to transmit the control signal to drive switching of set-top box playing and pause, switching of mute mode, adjusting of volume, and switching of channel switching, wherein the set-top box playing/pause button, the mute mode button, the two volume adjustment buttons, and the two channel switching buttons each have an outer contour that has a shape of one of a circle, a square, a triangle, a rhombus, or a combination thereof.

2. The simplified universal remote control according to claim 1, wherein the set-top box playing/pause button, the mute mode button, the two volume adjustment buttons, and the two channel switching buttons are all arranged on a surface of the upper casing member.

3. The simplified universal remote control according to claim 2, wherein the set-top box playing/pause button, the mute mode button, the two volume adjustment buttons, and the two channel switching buttons are arranged on the surface of the upper casing member such that every two adjacent ones of the buttons are spaced from each other by a constant distance.

4. The simplified universal remote control according to claim 1, wherein at least one of the set-top box playing/pause button, the mute mode button, the two volume adjustment buttons, and the two channel switching buttons is arranged on a surface of the lower casing member.

5. The simplified universal remote control according to claim 1, wherein the set-top box playing/pause button, the mute mode button, the two volume adjustment buttons, and the two channel switching buttons have outside colors that are of a same color, a same color system, different colors, or different color systems.

6. The simplified universal remote control according to claim 1, wherein every two of the set-top box playing/pause button, the mute mode button, the two volume adjustment buttons, and the two channel switching buttons have sizes that are identical or different.

7. The simplified universal remote control according to claim 1 further comprising a set-top box switch button that is arranged on the upper casing member or the lower casing member.

8. The simplified universal remote control according to claim 7, wherein the set-top box switch button has an outer contour that has a shape of one of a circle, a square, a triangle, a rhombus, or a combination thereof.

9. The simplified universal remote control according to claim 1 further comprising an indicator light arranged on the upper casing member or the lower casing member, the indicator light displaying at least one color according to the control signal.

10. The simplified universal remote control according to claim 1 further comprising a setting button that is arranged on the upper casing member or the lower casing member.
